(19) United States
(12) Patent Application Publication
(10) Pub. No.: US 2026/0277159 A1
(43) Pub. Date: Sep. 17, 2026

(54) PALLET STONE HOLDING STRUCTURE AND WATCH

(71) Applicant: CITIZEN WATCH CO., LTD., Tokyo (JP)

(72) Inventors: Kazutaka IGARASHI, Tokyo (JP); Yusuke HIROTA, Tokyo (JP); Shotaro INOUE, Tokyo (JP); Yasuyuki HIRAI, Tokyo (JP)

(73) Assignee: CITIZEN WATCH CO., LTD., Tokyo (JP)

(21) Appl. No.: 19/451,574

(22) Filed: Jan. 16, 2026

(30) Foreign Application Priority Data
Mar. 17, 2025 (JP) 2025-042299

(51) Int. Cl. G04B 15/14

(52) U.S. Cl. CPC G04B 15/14

(57) ABSTRACT

A pallet stone holding structure includes a pallet stone and a pallet stone holding member. The pallet stone has a fixing surface including an adhesive holding region provided with a plurality of recessed grooves, which is a plurality of recesses, and includes a meshing portion that meshes with an index wheel, which is a gear. The pallet stone holding member has a fixed surface in a flat surface shape to which the pallet stone is fixed with an adhesive applied to the adhesive holding region.

### CROSS-REFERENCE TO RELATED APPLICATION(S)

The present application claims priority to and incorporates by reference the entire contents of Japanese Patent Application No. 2025-042299 filed in Japan on March 17, 2025.

### BACKGROUND OF THE INVENTION

### Field of the Invention

The present invention relates to a pallet stone holding structure and a watch.

### Description of the Related Art

As a technique related to a conventional pallet stone holding structure and a watch, for example, Japanese National Publication of International Application No. 2013-535012 discloses an anchor that is a component of an escapement system of a watch and holds a pallet stone that meshes with an escape wheel. The pallet stone is held in the anchor by a pallet stone holding structure. The pallet stone holding structure is formed such that a joint is disposed in a gap between the pallet stone and the anchor, in a bifurcated housing of the anchor. The joint is made of amorphous metal or alloy.

Meanwhile, with such a pallet stone holding structure and watch, for example, the pallet stone may be fixed to a pallet stone holding member such as the anchor by using an adhesive. It is desirable that the adhesive is uniformly applied to a fixing surface of the pallet stone in order to reliably hold the pallet stone. In this respect, there is room for further improvement in a configuration in which the pallet stone is held by the pallet stone holding member.

### SUMMARY OF THE INVENTION

The present invention has been made in view of the foregoing, and it is an object of the present invention to provide a pallet stone holding structure and a watch that can appropriately hold a pallet stone to a pallet stone holding member.

In order to solve the above mentioned problem and achieve the object, a pallet stone holding structure according to one aspect of the present invention includes a pallet stone having a fixing surface including an adhesive holding region provided with a plurality of recesses and including a meshing portion that meshes with a gear; and a pallet stone holding member having a fixed surface in a flat surface shape to which the pallet stone is fixed with an adhesive applied to the adhesive holding region.

In order to solve the above mentioned problem and achieve the object, a watch according to another aspect of the present invention includes a pallet stone holding structure including a pallet stone having a fixing surface including an adhesive holding region provided with a plurality of recesses and including a meshing portion that meshes with a gear, and a pallet stone holding member having a fixed surface in a flat surface shape to which the pallet stone is fixed with an adhesive applied to the adhesive holding region; and the gear that constitutes a wheel train that rotates a hand and meshes with the meshing portion of the pallet stone.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a configuration of a tuning fork and a periphery thereof according to an embodiment;

FIG. 2 is a block diagram illustrating a configuration of a watch according to the embodiment;

FIG. 3 is an enlarged view for describing a state in which pallet stones of an entry pallet and exit pallet are meshed with an index wheel according to the embodiment;

FIG. 4 is a perspective view illustrating a pallet stone holding structure according to the embodiment;

FIG. 5 is a perspective view illustrating the pallet stone holding structure according to the embodiment;

FIG. 6 is a perspective view illustrating a pallet stone according to the embodiment; and

FIG. 7 is a plan view illustrating the pallet stone holding structure according to the embodiment.

### DETAILED DESCRIPTION OF THE PREFERRED EMBODIMENTS

Hereinafter, an embodiment according to the present invention will be described in detail with reference to the drawings. Note that this invention is not limited to the embodiment. Furthermore, components in the following embodiment include components that those skilled in the art can easily replace or components that are substantially the same.

### Embodiment

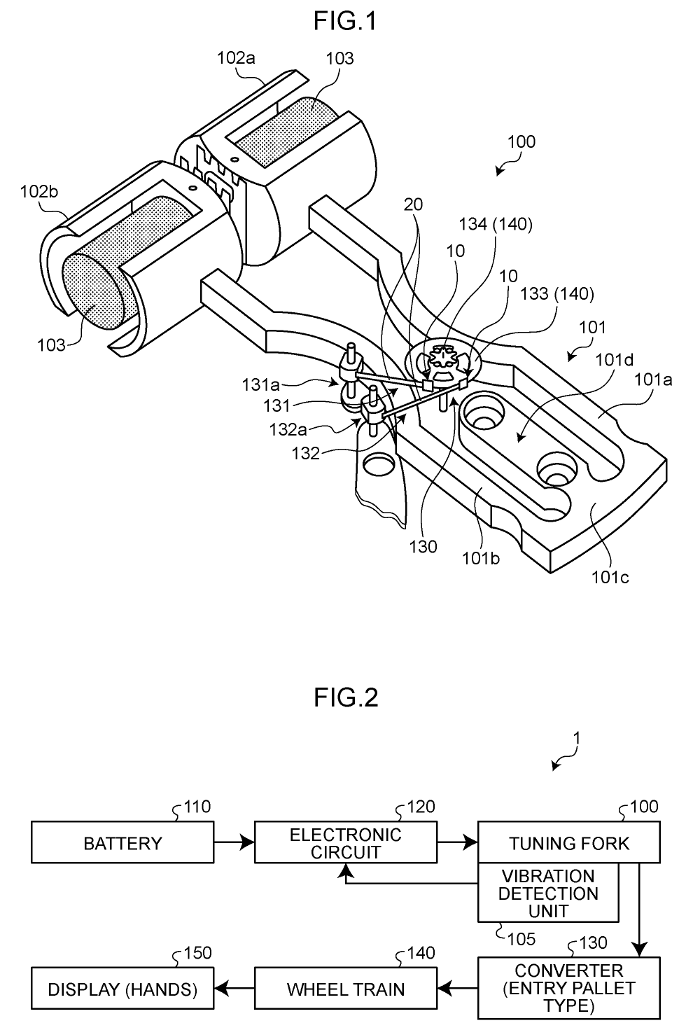

As illustrated in FIGS. 1 and 2, a tuning-fork watch 1 is provided with a tuning fork 100. The tuning fork 100 is a speed governor of the tuning-fork watch 1, and vibration of the tuning fork 100 is converted into a rotational motion by a converter 130. Output from the converter 130, which is the rotational motion, drives hands 150 via a wheel train 140.

As illustrated in FIG. 1, the tuning fork 100 includes a tuning-fork main body 101 formed in a bifurcated shape. The tuning-fork main body 101 has two vibration arms 101a and 101b extending in a long strip from a base 101c. An attachment 101d having two through holes is provided between the two vibration arms 101a and 101b. Via the through holes of the attachment 101d, the tuning fork 100 (tuning-fork main body 101) can be fixed to a housing of the tuning-fork watch 1.

Tip ends of the vibration arms 101a and 101b of the tuning-fork main body 101 are provided with cylindrical cups 102a and 102b each having a substantially bottomed cylindrical shape, respectively. A permanent magnet 103 having a substantially columnar shape is provided inside each of the cups 102a and 102b. A drive coil (not illustrated) is provided between the cups 102a and 102b and the respective permanent magnets 103. Furthermore, either the cup 102a or the cup 102b of the two cups 102a and 102b is provided with a detection coil (not illustrated) that detects vibration of the tuning fork 100.

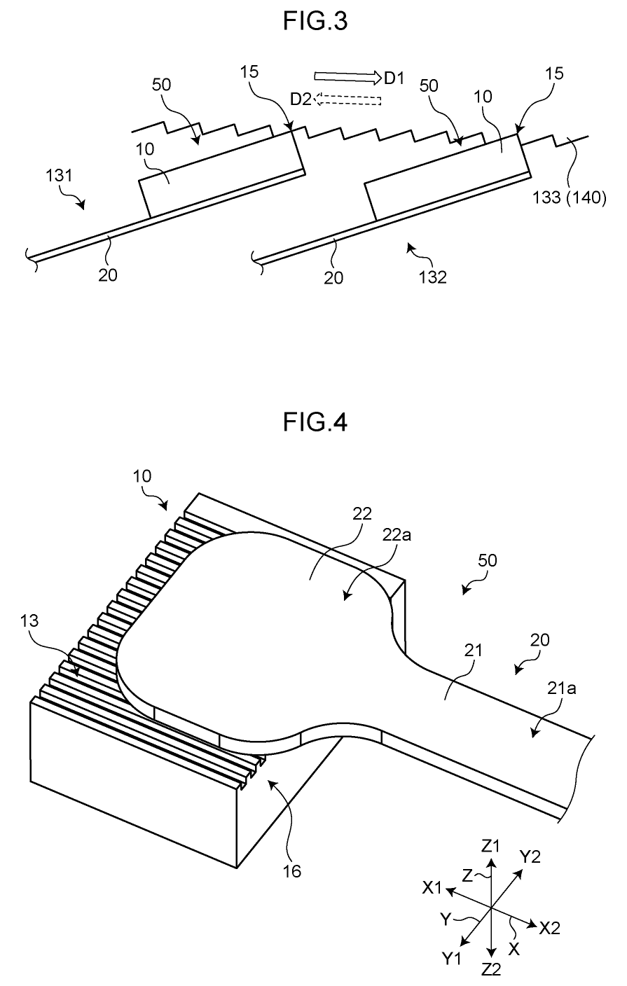

The converter 130 includes an entry pallet 131, an exit pallet 132, an index wheel 133, and a pinion gear 134. Note that the index wheel 133 and the pinion gear 134 are parts of and constitute the wheel train 140 that rotates the hands 150, in order to transmit the rotational motion to the hands 150. Both the entry pallet 131 and the exit pallet 132 are configured in a similar manner, and each of which includes a pallet stone holding member 20 and a pallet stone 10. The pallet stone 10 is held at a tip end of the pallet stone holding member 20 by a pallet stone holding structure 50 (refer to FIG. 3). That is, the pallet stone holding structure 50 of the entry pallet 131 and the pallet stone holding structure 50 of the exit pallet 132 have a similar structure. A base 131a supporting the entry pallet 131 is fixed to the vibration arm 101b of the tuning-fork main body 101. Meanwhile, a base 132a supporting the exit pallet 132 is fixed to the housing of the tuning-fork watch 1.

Although described in detail later, each pallet stone 10 of the entry pallet 131 and the exit pallet 132 is meshed with the index wheel 133 which is a ratchet wheel. The index wheel 133 is connected to gears in the wheel train 140, the gears moving the hands 150 via the pinion gear 134.

As illustrated in FIG. 2, the tuning-fork watch 1 is provided with a battery 110 serving as a drive source and an electronic circuit 120 through which a current from the battery 110 flows. The vibration arms 101a and 101b of the tuning fork 100 vibrate at 360 times of vibration per second = 360 Hz by the current flowing from the electronic circuit 120. When the battery 110 is incorporated, a vibration detection unit 105 including the detection coil described above detects vibration. Then, force for vibrating the tuning fork 100 is generated in the electronic circuit 120, and the vibration arms 101a and 101b of the tuning fork 100 start to vibrate.

The vibration of the tuning fork 100 is converted into the rotational motion by the converter 130. Specifically, as illustrated in FIG. 3, the entry pallet 131 fixed to the vibration arm 101b of the tuning fork 100 is meshed with the index wheel 133 and drives the index wheel 133 one tooth at a time in a driving direction D1 (forward rotation direction) every time the tuning fork 100 vibrates one time. Here, the index wheel 133 is biased in a direction D2 (reverse rotation direction) opposite to the direction D1 in which the entry pallet 131 drives. In order to regularly rotate the index wheel 133, the entry pallet 131 drives the index wheel 133, and then the exit pallet 132 meshes with the index wheel 133 so as to hold the index wheel 133 at a regulated position. In this way, the vibration of the tuning fork 100 is converted into the rotational motion, and the hands 150 are rotated by the wheel train 140, and the tuning-fork watch 1 is operated.

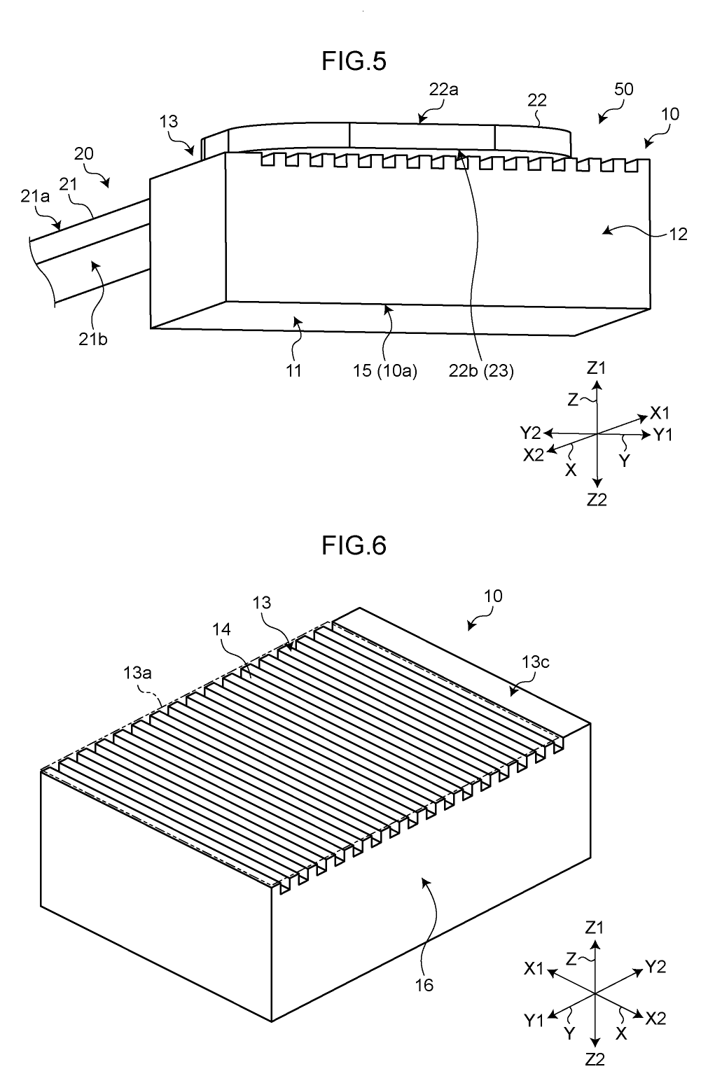

The pallet stone holding structure 50 including the pallet stone 10 and the pallet stone holding member 20 will be described in detail with reference to FIGS. 4 to 7. Note that, in the following description, a direction in which the pallet stone holding member 20 extends is referred to as an extending direction X, and two directions orthogonal to and intersecting the extending direction X are referred to as a width direction Y and a height direction Z. The extending direction X is a depth direction of the pallet stone 10, the width direction Y is a width direction of the pallet stone 10, and the height direction Z is a height direction of the pallet stone 10. Furthermore, in the extending direction X, one side is defined as one side X1, and another side is defined as another side X2. Similarly, one side Y1 and another side Y2 are defined for the width direction Y, and one side Z1 and another side Z2 are defined for the height direction Z.

As illustrated in FIGS. 4 and 5, the pallet stone holding member 20 is formed of a stainless-steel material and includes a supporting portion 21 and a fixed portion 22. The supporting portion 21 of the pallet stone holding member 20 is formed in a substantially flat bar shape that is long along the extending direction X. The fixed portion 22 of the pallet stone holding member 20 is provided at a tip end of the supporting portion 21 and is formed in a substantially long rectangular shape having a substantially flat plate shape. A length in the width direction Y of the fixed portion 22 is formed to be longer than a length of the supporting portion 21 in the width direction Y. Corners of the fixed portion 22 are rounded. Plate surfaces 22a and 22b, which are surfaces of the one side Z1 and another side Z2 in the height direction Z of the fixed portion 22, are formed in a substantially flat surface shape. The plate surfaces 22a and 22b are continuous with plate surfaces 21a and 21b of the supporting portion 21, and the plate surfaces 21a and 21b are also formed in a substantially flat surface shape. Of the plate surfaces 22a and 22b of the fixed portion 22, the plate surface 22b on another side Z2 in the height direction Z is a fixed surface 23 to which the pallet stone 10 is fixed.

The pallet stone 10 is formed of silicon and in a rectangular parallelepiped shape. The pallet stone 10 has six long rectangular surfaces in which the surfaces facing the height direction Z are formed to be larger than the surfaces facing the width direction Y and the extending direction X. A surface of the one side Z1 in the height direction Z of the pallet stone 10 is a fixing surface 13 fixed to the fixed surface 23 of the pallet stone holding member 20. The surfaces of the pallet stone 10 other than the fixing surface 13 are formed in a flat surface shape. As illustrated in FIG. 6, the fixing surface 13 includes an adhesive holding region 13a where an applied adhesive is held. The adhesive holding region 13a is provided with a plurality of recessed grooves 14 as a plurality of recesses. Each of the recessed grooves 14 extends from one end to another end of the fixing surface 13, that is, from the one side X1 to another side X2 in the extending direction X of the fixing surface 13. In other words, each of the recessed grooves 14 is formed as a groove penetrating the fixing surface 13 in the extending direction X. The plurality of recessed grooves 14 is arranged at equal intervals along the width direction Y.

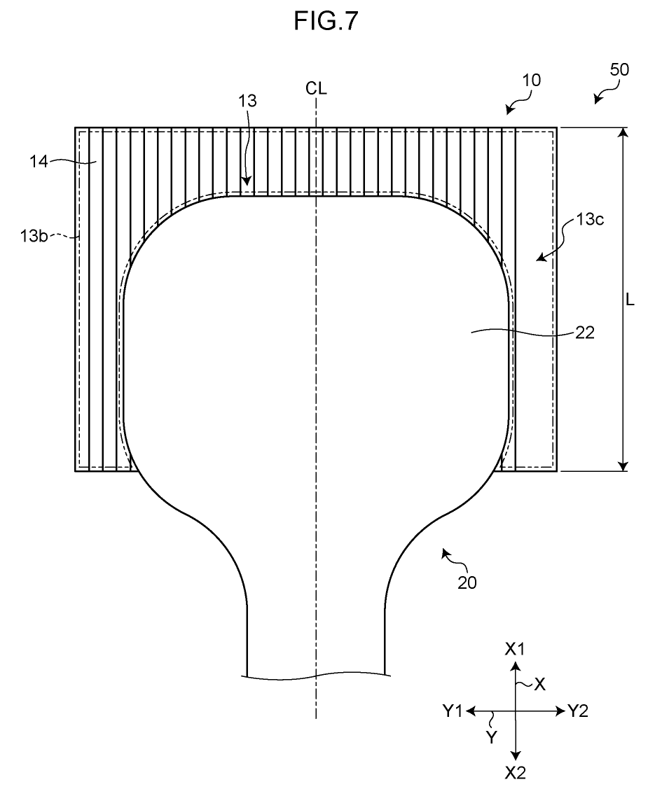

As illustrated in FIG. 7, the fixing surface 13 includes a region not overlapping with the fixed portion 22, that is, a non-contact region 13b not in contact with the fixed surface 23. In the present embodiment, the non-contact region 13b is a region outside the fixed portion 22 on the fixing surface 13. More specifically, the non-contact region 13b is provided on the one side Y1 and another side Y2 in the width direction Y of the fixed portion 22, and on the one side X1 in the extending direction X of the fixed portion 22. Therefore, the fixed surface 23 can come into contact with the adhesive holding region 13a holding the adhesive on an entire surface thereof. As a result, the pallet stone 10 can be firmly fixed to the fixed surface 23.

The non-contact region 13b includes a mark region 13c formed in a flat surface shape. The mark region 13c is a region for recognizing a position at which a meshing portion 15 is disposed. In the present embodiment, the mark region 13c is formed in a substantially long rectangular shape with the extending direction X as a longitudinal direction. The mark region 13c is provided at an end on another side Y2 in the width direction Y of the fixing surface 13. Therefore, the fixing surface 13 is formed asymmetrically with respect to a center line CL on the fixing surface 13 in the width direction Y.

As illustrated in FIG. 5, a surface on another side Z2 in the height direction Z of the pallet stone 10 (surface facing the fixing surface 13) is a first meshing surface 11. Furthermore, a surface connected to the fixing surface 13 and the first meshing surface 11 and provided on the one side X1 in the extending direction X of the recessed grooves 14 (one end side of the recessed grooves 14) is a second meshing surface 12. A corner 10a where the first meshing surface 11 and the second meshing surface 12 are connected to each other serves as the meshing portion 15. The meshing portion 15 meshes with ratchet teeth of the index wheel 133 which is a gear (refer to FIGS. 1 and 3). Note that the meshing portion 15 can be formed over a whole or part of the corner 10a in the width direction Y. Furthermore, a surface on another side X2 in the extending direction X of the pallet stone 10 (surface facing the second meshing surface 12) serves as a polished surface 16. The polished surface 16 is disposed on another side X2 in the extending direction X of the pallet stone holding member 20 (base end side of the pallet stone holding member 20).

The pallet stone 10 is manufactured by using silicon obtained by performing a cutting process on a single-crystal ingot manufactured by dissolving polycrystalline silicon. The pallet stone 10 is fixed to the fixed surface 23 of the pallet stone holding member 20 by applying the adhesive to the fixing surface 13 provided with the plurality of recessed grooves 14. Here, as described above, the pallet stone 10 is meshed with the gear at the meshing portion 15. Therefore, the pallet stone 10 needs to be fixed on a condition that a position of the meshing portion 15 with respect to the pallet stone holding member 20 is accurate. Therefore, for example, the pallet stone 10 is accurately positioned by using a jig and fixed to the pallet stone holding member 20. In order to position the pallet stone 10 accurately with a jig, it is necessary to minimize a tolerance of a length in the extending direction X of the pallet stone 10 (dimension L illustrated in FIG. 7).

Therefore, the dimension L of the pallet stone 10 is formed accurately by polishing. The pallet stone 10 can be polished by, for example, a polishing apparatus in which a polishing pad to which polishing slurry is applied is provided on a wheel. Here, a minute burr (also referred to as burr) may be generated on a polished surface. If the minute burr is generated on the meshing portion 15, the pallet stone 10 may not be able to appropriately mesh with the gear. Therefore, with regard to the pallet stone 10, either of two surfaces facing in the extending direction X is polished, and the polished surface serves as the polished surface 16 and an unpolished surface serves as the second meshing surface 12. Note that the unpolished surface of the pallet stone 10 is a surface cut out by the cutting process as described above, and no minute burr is generated.

Here, because the pallet stone 10 is a minute component, and the polished surface is almost the same as the unpolished surface in appearance, it is difficult to determine with a naked eye which surface is the polished surface 16. However, with regard to the pallet stone 10 in the present embodiment, a direction of the polished surface 16 can be identified by using the mark region 13c as a mark. When the pallet stone 10 is fixed to the pallet stone holding member 20, the pallet stone 10 is fixed to the fixed surface 23 such that the mark region 13c of the pallet stone 10 is positioned on the one side Y1 in the width direction Y of the pallet stone 10. Then, the polished surface 16 is disposed on another side X2 in the extending direction X of the pallet stone holding member 20 (base end side of the pallet stone holding member 20). Therefore, the pallet stone 10 is not fixed in a direction in which the burred polished surface 16 is meshed with the gear, and thus it is possible to prevent the burr from cutting and wearing the gear when the pallet stone 10 meshes with the gear and prevent the pallet stone 10 from not being able to appropriately mesh with the gear.

Furthermore, the plurality of recessed grooves 14 can be formed by dry etching. Therefore, the mark region 13c can be easily formed by being masked so that the recessed grooves 14 are not formed thereon. Then, because the mark region 13c is provided in the non-contact region 13b, there is no influence on adhesion of the pallet stone 10 even though the mark region has a flat surface shape.

The pallet stone holding structure 50 described above includes the pallet stone 10 having the fixing surface 13 including the adhesive holding region 13a provided with the plurality of recessed grooves 14, which is a plurality of recesses, and including the meshing portion 15 that meshes with the index wheel 133, which is a gear, and the pallet stone holding member 20 having the fixed surface 23 in a flat surface shape to which the pallet stone 10 is fixed with the adhesive applied to the adhesive holding region 13a. Then, the tuning-fork watch 1, which is the watch, includes the pallet stone holding structure 50 and the index wheel 133, which is the gear that constitutes a wheel train 140 that rotates the hands 150 and meshes with the meshing portion 15 of the pallet stone 10.

As a result, even in a case where the adhesive is applied to the fixing surface 13, the adhesive is held in the plurality of recesses. Therefore, because the adhesive spreads by surface tension along each of the recessed grooves 14, the adhesive does not stay on a part of the fixing surface 13 and is provided between an entire surface of the fixed surface 23 and the fixing surface 13. Therefore, because the pallet stone 10 is more firmly bonded and fixed to the fixed surface 23, the pallet stone holding member 20 can appropriately hold the pallet stone 10.

Furthermore, each of the recesses is a recessed groove 14 extending from one end to the another end (from one side X1 to the another side X2 in the extending direction X) of the fixing surface 13. As a result, the recesses, which are the recessed grooves 14, can be easily formed by dry etching.

Furthermore, the pallet stone is formed of silicon in a rectangular parallelepiped shape. The meshing portion 15 is formed on a corner 10a where the first meshing surface 11 facing the fixing surface 13 and the second meshing surface 12 connected to the fixing surface 13 and the first meshing surface 11 and provided on the one side X1 of the extending direction X, which is the one end side of the recessed grooves 14, are connected to each other. The surface facing the second meshing surface 12 of the pallet stone 10 serves as the polished surface 16, and the polished surface 16 is disposed on the base end side, that is, another side X2 in the extending direction X, of the pallet stone holding member 20. As a result, the meshing portion 15 does not include the polished surface 16 on which a minute burr may be generated, and thus the pallet stone 10 and the index wheel 133 can be appropriately meshed with each other.

Furthermore, the fixing surface 13 includes the non-contact region 13b not in contact with the fixed surface 23, the non-contact region 13b includes the mark region 13c formed in a flat surface shape. The fixing surface 13 is formed asymmetrically with respect to the center line CL in the width direction Y, which is a direction orthogonal to the extending direction X of the recessed grooves 14. As a result, a position of the polished surface 16 can be visually identified and the pallet stone 10 can be fixed to the pallet stone holding member 20.

Note that the pallet stone holding structure and the watch according to the embodiment of the present invention described above are not limited to the embodiment described above, and various modifications can be made within the scope described in the claims.

In the above description, the pallet stone 10 is formed using silicon, but, for example, other materials can be used as long as the materials can be processed by high-precision fine processing using an LIGA process or the like (micro-electro-mechanical systems (MEMS)). Furthermore, the recesses are not limited to the recessed grooves 14, and may be recesses in another form, such as a large number of recesses recessed from a flat surface. Furthermore, although the recessed grooves 14 are formed linearly in the extending direction X, the recessed grooves 14 can be formed in another shape, for example, a shape of bottoms thereof is formed in an arc shape as viewed from the extending direction X. Furthermore, the pallet stone holding structure 50 is applied to the tuning-fork watch 1 but can also be applied as a pallet stone holding structure for a pallet stone held by an anchor as a pallet stone holding member in another type of watch, a mechanical watch, for example, and meshed with an escape wheel that is a gear that constitutes a wheel train. Furthermore, the fixed surface 23 of the pallet stone holding member 20 may be larger in size than the fixing surface 13 of the pallet stone 10.

The pallet stone holding structure and the watch according to the present embodiment may be configured by appropriately combining the components of the embodiment and the modifications described above.

A pallet stone holding structure and a watch according to the present embodiment are able to appropriately hold a pallet stone to a pallet stone holding member.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A pallet stone holding structure comprising:
a pallet stone having a fixing surface including an adhesive holding region provided with a plurality of recesses and including a meshing portion that meshes with a gear; and
a pallet stone holding member having a fixed surface in a flat surface shape to which the pallet stone is fixed with an adhesive applied to the adhesive holding region.

2. The pallet stone holding structure according to claim 1, wherein
each of the recesses is a recessed groove extending from one end of the fixing surface to another end of the fixing surface.

3. The pallet stone holding structure according to claim 2, wherein
the pallet stone is formed of silicon in a rectangular parallelepiped shape,
the meshing portion is formed on a corner where a first meshing surface and a second meshing surface are connected to each other, the first meshing surface facing the fixing surface, and the second meshing surface being connected to the fixing surface and the first meshing surface and provided on one end side of the recessed groove,
a surface facing the second meshing surface of the pallet stone serves as a polished surface, and
the polished surface is disposed on a base end side of the pallet stone holding member.

4. The pallet stone holding structure according to claim 3, wherein
the fixing surface includes a non-contact region not in contact with the fixed surface,
the non-contact region includes a mark region formed in a flat surface shape, and
the fixing surface is formed asymmetrically with respect to a center line in a direction orthogonal to an extending direction of the recessed groove.

5. A watch comprising:
a pallet stone holding structure including a pallet stone having a fixing surface including an adhesive holding region provided with a plurality of recesses and including a meshing portion that meshes with a gear, and a pallet stone holding member having a fixed surface in a flat surface shape to which the pallet stone is fixed with an adhesive applied to the adhesive holding region; and
the gear that constitutes a wheel train that rotates a hand and meshes with the meshing portion of the pallet stone.
